(19) United States
(12) Patent Application Publication
(10) Pub. No.: US 2006/0030354 A1
(43) Pub. Date: Feb. 9, 2006

(54) Method for selectively connecting multi-mode mobile phone with mobile communication network or wireless network

(75) Inventors: David Ho, Taipei (TW); Wen-Tao Lv, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/193,431

(22) Filed: Aug. 1, 2005

(30) Foreign Application Priority Data
Aug. 6, 2004 (TW) 093123629

(51) Int. Cl. H04Q 7/20

(52) U.S. Cl. 455/552.1

(57) ABSTRACT

A method for selectively connecting a multi-mode mobile phone with a mobile communication network or a wireless network is constructed among a mobile communication network, a wireless network and a multi-mode mobile phone, wherein the multi-mode mobile phone includes a first number corresponding to the mobile communication network, a second number corresponding to the wireless network, and a switching connection software. The multi-mode mobile phone can use the switching connection software to automatically connect the multi-mode mobile phone to the wireless network or the mobile communication network to maintain a better communication quality.

### FIELD OF THE INVENTION

The present invention relates to a method for connecting a mobile phone with a network, and more particularly to a method for selectively connecting a multi-mode mobile phone with a mobile communication network or a wireless network.

### BACKGROUND OF THE INVENTION

At present, most mobile phones are single-mode mobile phones that primarily support a Global System for Mobile Communication (GSM) network, a Code Division Multiple Access (CDMA) network or a dual-mode GSM/CDMA. Both of the single-mode phones and dual-mode phones have a common feature that require users to switch between different communication networks such as the GSM network and the CDMA network before obtaining the support of such network for normal operations.

As the number of mobile phone users is increased drastically, the operation of the communication network for mobile phones is overloaded. As a result, the mobile phone may be disconnected, interfered or having a poor conversation quality and difficulties for connecting the network.

Further, mobile communication network providers have to carry an expensive cost for the wideband and build huge base stations and networks for roaming, and thus making the telephone fees of mobile phones very high. Although some of the mobile phone manufacturers aggressively introduce a dual-mode or triple-mode mobile phone to integrate the Personal Handy-phone (PHS), GSM or CDMA systems, the cost of this kind of mobile phones is higher than those via the fixed telephone network or Internet. In view of this situation, some mobile phone manufacturers try to use the existing popular wireless local area network (Wireless LAN, WLAN).

Since a mobile phone operating in the WLAN mode is equivalent to an Internet phone (IP phone), and the Internet phone converts an audio signal into a packet in compliance with the Internet protocol. The packet is then sent via the Internet. Further, the Internet phone uses a software switch technology and the Internet instead of the non-fixed telephone network or mobile communication network, and the number of phone users is limited by the bandwidth of the network and is not restricted by the frequency at all. Therefore, the service providers do not have to pay expensive fees for the frequency or build huge roaming base station network, but they simply use the current existing Internet and WLAN, and thus the telephone fee is apparently “zero”.

Therefore, mobile phone manufacturers proposed a dual-mode mobile phone that simultaneously support Global System for Mobile Communication (GSM), Personal Handy-phone System (PHS) or Code Division Multiple Access (CDMA) system and WLAN, and designed a method for switching the network connection between the mobile phone communication network and the wireless local area network, so that the dual-mode mobile phone can freely switch its network connection between the mobile phone communication network and wireless local area according to the environment or actual operating requirements.

### SUMMARY OF THE INVENTION

In view of the shortcomings of the prior art, the inventor of the present invention based on years of practical experience to conduct extensive researches and experiments and developed a mobile phone for mobile communication network and wireless local area network, and the mobile phone is capable of efficiently switching between the mobile communication network and the wireless local area network. The invention is intended to enhance the phone conversation quality of the mobile phone and overcome the shortcomings including disconnection, poor phone conversation quality and difficulty of logging on of a prior art signal mode or multi-mode mobile phone. The inventor finally designed a method for selectively connecting a multi-mode mobile phone with a mobile communication network or a wireless network.

Therefore, it is a primary objective of the present invention to provide a method for selectively connecting a multi-mode mobile phone with a mobile communication network or a wireless network. The method is constructed among a mobile communication network, a wireless network and a multi-mode mobile phone. The multi-mode mobile phone comprises a first number corresponding to the mobile communication network, a second number corresponding to the wireless network and a switching connection software. The multi-mode mobile phone can use the switching connection software to automatically connect to the wireless network or the mobile communication network to maintain a better communication quality.

Another objective of the present invention is to provide the method further comprising a remote communication device, and the remote communication device regardless of having the first number or the second number, the multi-mode mobile phone can communicate with a remote communication device, if it is connected directly or indirectly to the wireless network or the mobile communication network.

### BRIEF DESCRIPTION OF THE DRAWINGS

FIG. 1 is a schematic view of a method architecture of the present invention;

FIG. 2 is a view of the internal architecture of a multi-mode mobile phone, a wireless network and a mobile communication network of the present invention;

FIG. 3 is a flow chart of the process of a method of the present invention;

FIG. 4 is a flow chart of the process of a multi-mode mobile phone automatic switching connection according to the present invention;

FIG. 5 is a flow chart of a remote communication device dialing a first number according to the present invention; and

FIG. 6 is a flow chart of a remote communication device dialing a second number according to the present invention.

### DETAILED DESCRIPTION OF THE PREFERRED EMBODIMENTS

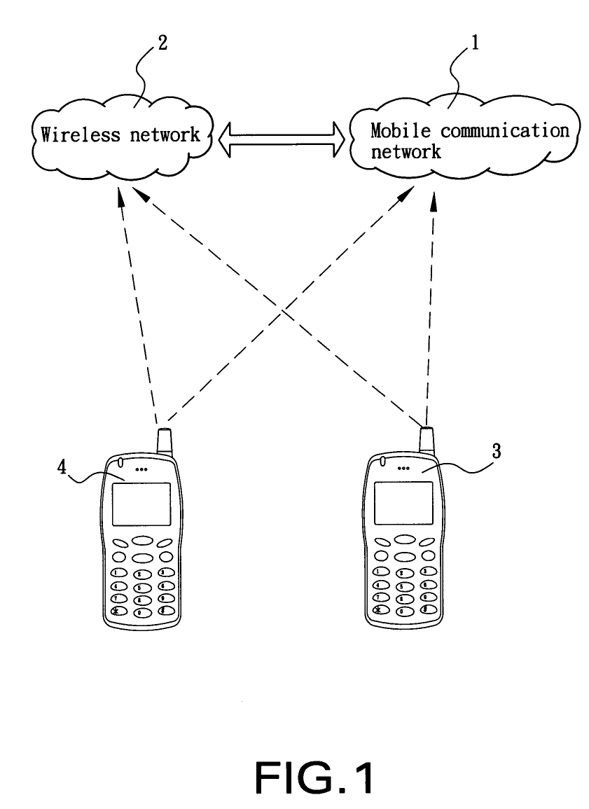

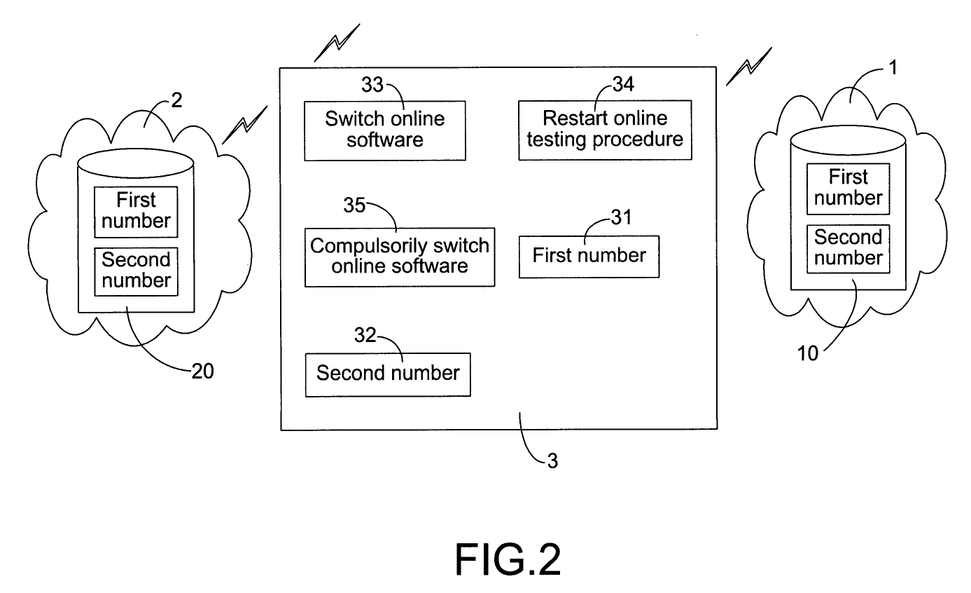

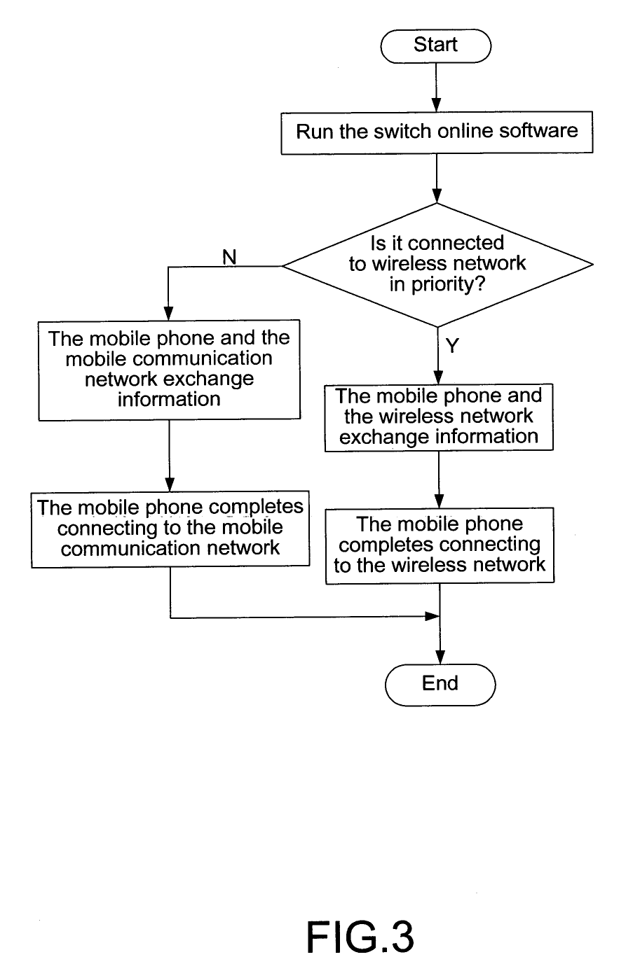

Referring to FIGS. 1 and 2 for the method of selectively connecting a multi-mode mobile phone with a mobile communication network or a wireless network in accordance with the present invention, the method is constructed among a mobile communication network 1, a wireless network 2 and a multi-mode mobile phone 3; wherein the multi-mode mobile phone 3 includes a first number 31 corresponding to the mobile communication network 1 such as the Global System for Mobile Communication (GSM), Personal Handy-phone System (PHS) or Code Division Multiple Access (CDMA) system, a second number 32 corresponding to the wireless network 2 and a switching connection software 33, in addition to the necessary components of a general multi-mode mobile phone. The switching connection software 33 can set the multi-mode mobile phone 3 after the switching connection software 33 is run. Referring to FIG. 3, the multi-mode mobile phone 3 has a first priority to be connected to the wireless network 2 and exchange information with the wireless network 2, such that the wireless network 2 keeps track of the multi-mode mobile phone 3 being connected, and the multi-mode mobile phone 3 can communicate (such as dialing a call, receiving a call or sending a short message, etc) through the wireless network 2. If the multi-mode mobile phone 3 cannot be connected to the wireless network 2, the multi-mode mobile phone 3 will be connected to the mobile communication network 1, and the multi-mode mobile phone 3 will exchange information via the mobile communication network 1. Therefore, the mobile communication network 1 can keep track of the multi-mode mobile phone 3 being connected. By then, the multi-mode mobile phone 3 will use the mobile communication network 1 for the communications. As a result, the multi-mode mobile phone 3 can achieve the purpose of being switched freely between the mobile communication network 1 and the wireless network 2.

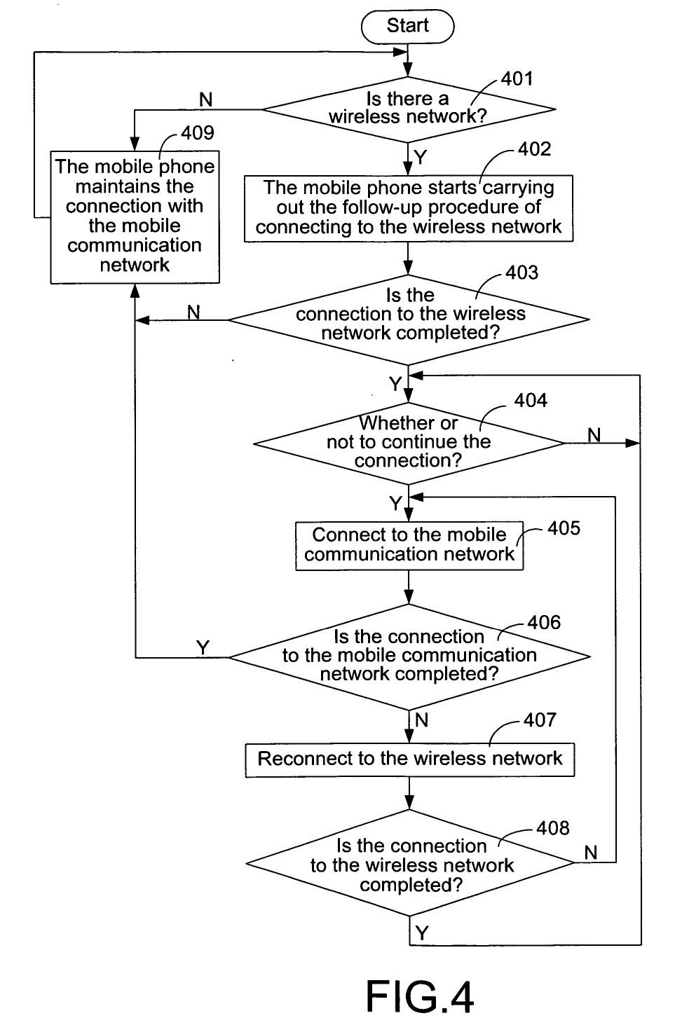

If the multi-mode mobile phone 3 is connected to the mobile communication network 1, and the multi-mode mobile phone 3 also can reconnect to the wireless network 2 to allow the multi-mode mobile phone 3 users to communicate with a lower fee according to the present invention, then the multi-mode mobile phone 3 may further include a reconnection testing procedure 34, so that the reconnection testing procedure 34 can be started when the multi-mode mobile phone 3 is connected to the mobile communication network 1, and the multi-mode mobile phone 3 can use the switching connection software 33 and the reconnection testing procedure 34 to carry out the following procedure as illustrated in FIGS. 1 and 4:

Step (401): Firstly, the multi-mode mobile phone 3 uses the reconnection testing procedure 34 to repeatedly detect whether or not the multi-mode mobile phone 3 includes the wireless network 2 in its application environment; if yes, then go to Step (402), or else go to Step (409);
Step (402): The multi-mode mobile phone 3 starts the follow-up procedure of connecting the wireless network 2;
Step (403): The multi-mode mobile phone 3 uses the reconnection testing procedure 34 again to determine whether or not the multi-mode mobile phone 3 completes the connection with the wireless network 2; if yes, then go to Step (404), or else go to Step (409);
Step (404): The multi-mode mobile phone 3 uses the switching connection software 33 to determine whether or not the connection with the wireless network 2 cannot be continued; if yes, then go to Step (405), or else go to Step (404);
Step (405): The multi-mode mobile phone 3 uses the switching connection software 33 to carry out the follow-up procedure of connecting to the mobile communication network 1;
Step (406): The multi-mode mobile phone 3 uses the switching connection software 33 to determine whether or not the multi-mode mobile phone 3 completes its connection with the mobile communication network 1; if yes, then go to Step (409), or else go to Step (407);
Step (407): The multi-mode mobile phone 3 uses the switching connection software 33 to carry out the follow-up procedure of connecting the wireless network 2 again;
Step (408): The multi-mode mobile phone 3 uses the switching connection software 33 to determine whether or not the multi-mode mobile phone 3 completes its connection with the wireless network 2; if yes, then go to Step (404), or else go to Step (405);
Step (409): The multi-mode mobile phone 3 maintains its connection to the mobile communication network 1, and then go to Step (401).

With the aforementioned procedure, the multi-mode mobile phone 3 has the first priority to connect to the wireless network 2 and also can connect to the mobile communication network 1. If the multi-mode mobile phone 3 has a chance to connect to the wireless network 2, it will try to connect to the wireless network 2, so that the multi-mode mobile phone 3 can reconnect to the wireless network 2. If the multi-mode mobile phone 3 is unable to connect to the wireless network 2, then it will try to connect to the mobile communication network 1, so that the multi-mode mobile phone 3 can switch between the mobile communication network 1 and the wireless network 2 automatically and use a lower fee and a first priority to connect the wireless network 2.

The aforementioned automatic switch procedure aims at the objective of saving costs for the multi-mode mobile phone 3 users. If it is necessary for the users to compulsorily maintain the connection to the mobile communication network 1 or the wireless network 2 in special occasions, then the aforementioned procedure will be a problem to users. Referring to FIGS. 1 and 2, the multi-mode mobile phone 3 installs a compulsory switching connection software 35, and after the multi-mode mobile phone 3 executes the compulsory switching connection software 35, the continual application of the switching connection software 33 and the reconnection testing procedure 34 will be stopped compulsorily, and the compulsory connection is specified to the mobile communication network 1 or the wireless network 2 until the multi-mode mobile phone 3 stops running the compulsory switching connection software 35, and then the multi-mode mobile phone 3 will continue using the switching connection software 33 and the reconnection testing procedure 34. As a result, the multi-mode mobile phone 3 can freely switch between the mobile communication network 1 and the wireless network 2 according to actual needs.

Further, the above description indicates that the invention has considered the connection of a multi-mode mobile phone 3 with the mobile communication network 1 or the wireless network 2, but it has not described how the multi-mode mobile phone 3 connects to the mobile communication network 1 or the wireless network 2 after a remote communication device 4 (such as a city phone, a mobile phone or an Internet phone, etc) dials the first number 31 or the second number 32. The following describes the procedure of the mobile communication network 1 or the wireless network 2 after the remote communication device 4 dials the first number 31 or second number 32.

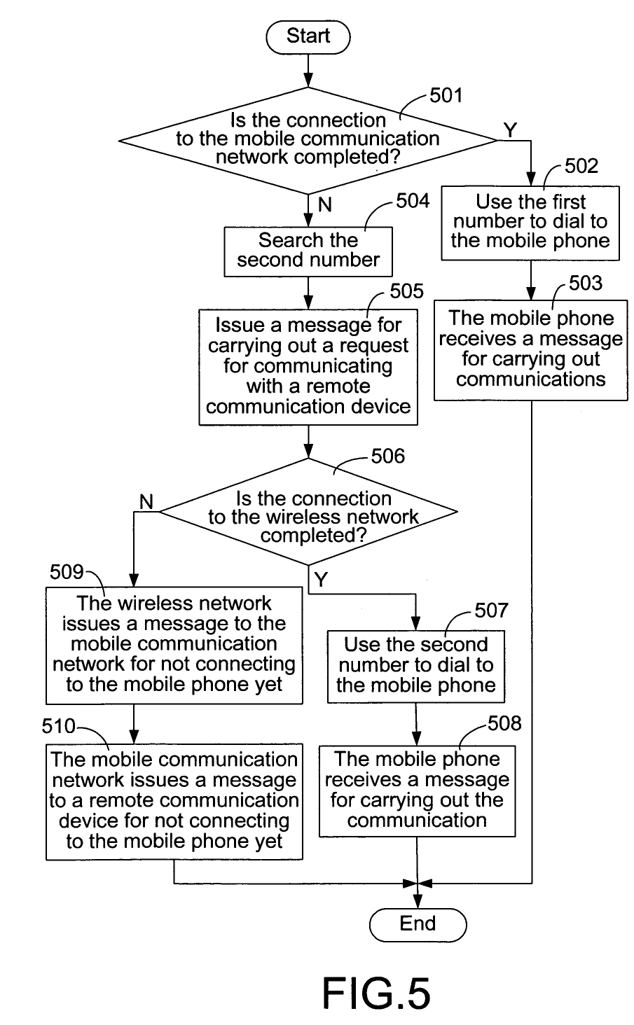

Referring to FIGS. 1, 2 and 5, the mobile communication network 1 or the wireless network 2 in accordance with the present invention records the first number 31 and second number 32 of the multi-mode mobile phone 3 in a number database 10, 20 separately, and after the remote communication device 4 dials the first number 31, the remote communication device 4 will connect to the mobile communication network 1, and the following procedure will be carried out among the mobile communication network 1, the wireless network 2 and the multi-mode mobile phone 3, such that the remote communication device 4 can communicate with the multi-mode mobile phone 3.
Step (501): Firstly, the mobile communication network 1 determines whether or not the multi-mode mobile phone 3 completes its connection; if yes, then go to Step (502), or else go to Step (504);
Step (502): The mobile communication network 1 directly uses the first number 31 to dial to the multi-mode mobile phone 3;
Step (503): The multi-mode mobile phone 3 receives a message (such as a ring tone) requesting for a communication from the remote communication device 4;
Step (504): The mobile communication network 1 searches the second number 32 of the multi-mode mobile phone 3 according to the first number 31;
Step (505): The mobile communication network 1 issues a message to the wireless network 2 requesting for a communication between the remote communication device 4 and the multi-mode mobile phone and connects the remote communication device 4 to the wireless network 2 through the mobile communication network 1;
Step (506): The wireless network 2 determines whether or not the multi-mode mobile phone 3 completes its connection; if yes, then go to Step (507), or else go to Step (509);
Step (507): The wireless network 2 uses the second number 32 to dial to the multi-mode mobile phone 3;
Step (508): The multi-mode mobile phone 3 receives a message (such as a ring tone) requesting for a communication with the remote communication device 4, and then the multi-mode mobile phone 3 is connected to the remote communication device 4 through the mobile communication network 1 and the wireless network 2;
Step (509): The wireless network 2 issues a message to the mobile communication network 1 for being not connected to the multi-mode mobile phone 3; and
Step (510) The mobile communication network 1 issues a message to the remote communication device 4 for being not connected to the multi-mode mobile phone 3 according to the message for being not connected to the multi-mode mobile phone 3 issued by the wireless network 2.

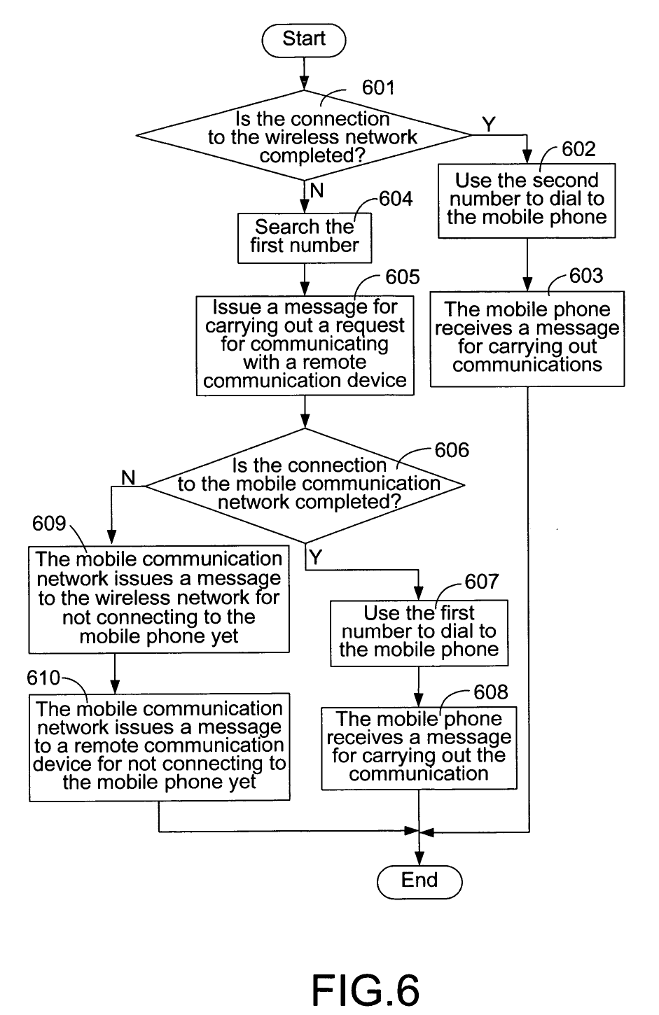

Referring to FIGS. 1 and 6, the remote communication device 4 will connect to the wireless network 2, after the remote communication device 4 of the invention dials the second number 32, and the following procedure will be carried out among the wireless network 2, the mobile communication network 1 and the multi-mode mobile phone 3, such that the remote communication device 4 can communicate with the multi-mode mobile phone 3.
Step (601): Firstly, the wireless network 2 determines whether or not the multi-mode mobile phone 3 completes its connection; if yes, then go to Step (602), or else go to Step (604);
Step (602): The wireless network 2 directly uses the second number 32 to dial to the multi-mode mobile phone 3;
Step (603): The multi-mode mobile phone 3 receives a message (such as a ring tone) requesting for a communication from the remote communication device 4;
Step (604): The wireless network 2 searches the first number 31 of the multi-mode mobile phone 3 according to the second number 32;
Step (605): The wireless network 2 issues a message to the mobile communication network 1 requesting for a communication between the remote communication device 4 and the multi-mode mobile phone 3, so that the remote communication device 4 connects to the mobile communication network 1 through the wireless network 2;
Step (606): The mobile communication network 1 determines whether or not the multi-mode mobile phone 3 completes its connection; if yes, then go to Step (607), or else go to Step (609);
Step (607): The mobile communication network 1 uses the first number 31 to dial to the multi-mode mobile phone 3;
Step (608): The multi-mode mobile phone 3 receives a message (such as a ring tone) from the remote communication device 4 requesting for a communication with the multi-mode phone 3, and then the multi-mode mobile phone 3 connects to the remote communication device 4 through the wireless network 2 and the mobile communication network 1;
Step (609): The mobile communication network 1 issues a message to the wireless network 2 for not connecting the multi-mode mobile phone 3; and
Step (610): The wireless network 2 issues a message to the remote communication device 4 for being not connected to the multi-mode mobile phone 3 according to the message for being not connected to the multi-mode mobile phone 3 issued by the mobile communication network 1.

In summation to the above description, the multi-mode mobile phone 3 regardless of its connecting to the mobile communication network 1 or the wireless network 2, and the remote communication device 4 regardless of dialing the first number 31 or second number 32 can be connected to the remote communication device 4. Further, the multi-mode mobile phone 3 can have an automatic switching connection or a compulsory switching connection between the mobile communication network 1 and the wireless network 2. Thus, the present invention can overcome the shortcomings of a prior art multi-mode mobile phone 3.

What is claimed is:

1. A method for selectively connecting a multi-mode mobile phone with a mobile communication network or a wireless network, said method being constructed among a mobile communication network, a wireless network and a multi-mode mobile phone, wherein said multi-mode mobile phone has a first number corresponding to said mobile communication network, a second number corresponding to said wireless network and a switching connection software, and said mobile communication network and said wireless network each include a number database, and said number database each records said respective first number and second number of said multi-mode mobile phone, and after said multi-mode mobile phone is turned on said method comprises the steps of:
connecting said multi-mode mobile phone, by using said switching connection software, to said wireless network with a first priority;
performing an information exchange by said multi-mode mobile phone with said wireless network; and
communicating performed by said multi-mode mobile phone by way of said wireless network after said wireless network records that said multi-mode mobile phone completes its connection with said wireless network.

2. The method of claim 1, further comprising:
if said multi-mode mobile phone is unable to be connected to said wireless network, connecting said multi-mode mobile phone to said mobile communication network;
performing said information exchange by said multi-mode mobile phone with said mobile communication network;
communicating performed by said multi-mode mobile phone by way of said mobile communication network after said wireless network records that said multi-mode mobile phone completes its connection with said mobile communication network.

3. The method of claim 2, wherein said multi-mode mobile phone is able to use a reconnection testing procedure that is performed when said multi-mode mobile phone is connected to said mobile communication network, while said multi-mode mobile phone being capable of being reconnected to said wireless network, said method further comprises the steps of:
said multi-mode mobile phone using said reconnection testing procedure to repeatedly detect whether or not said multi-mode mobile phone has said wireless network in its application environment;
said multi-mode mobile phone starting a follow-up procedure for connecting to said wireless network, if said multi-mode mobile phone has said wireless network in its application environment;
said multi-mode mobile phone using said reconnection testing procedure to determine whether or not said multi-mode mobile phone completes its connection with said wireless network;
said multi-mode mobile phone using said switching connection software to determine whether or not said multi-mode mobile phone is unable to continue its connection with said wireless network, if said multi-mode mobile phone is connected with said wireless network; and
repeating the previous step of determining whether or not said multi-mode mobile phone is unable to continue its connection with said wireless network, if said multi-mode mobile phone is able to continue its connection with said wireless network.

4. The method of claim 3, wherein said multi-mode mobile phone maintains its connection with said mobile communication network, if said wireless network is not detected in the application environment of said multi-mode mobile phone, and said method further comprises:
repeating the previous step in claim 3 that said multi-mode mobile phone uses said reconnection testing procedure to repeatedly detect whether or not said multi-mode mobile phone has said wireless network in its application environment.

5. The method of claim 3, wherein said multi-mode mobile phone uses said reconnection testing procedure to determine if said multi-mode mobile phone is not connected to said wireless network, and said multi-mode mobile phone maintains its connection with said mobile communication network and then returns to said reconnection testing procedure to repeatedly determine whether or not said multi-mode mobile phone includes the procedure of said wireless network in the application environment.

6. The method of claim 3, wherein said multi-mode mobile phone uses said switching connection software to determine if said multi-mode mobile phone is unable to continue its connection with said wireless network, and then said multi-mode mobile phone uses said switching connection software to carry out a follow-up procedure of connecting to said mobile communication network;
said multi-mode mobile phone uses said switching connection software to determine whether or not said multi-mode mobile phone completes its connection with said mobile communication network;
said multi-mode mobile phone maintains its connection with said mobile communication network, if said multi-mode mobile phone completes its connection with said mobile communication network, and then returns to said reconnection testing procedure to repeatedly detect whether said multi-mode mobile phone includes a procedure of said wireless network in its application environment.

7. The method of claim 6, wherein said multi-mode mobile phone uses said switching connection software to determine if said multi-mode mobile phone is not connected with said mobile communication network, and then said multi-mode mobile phone uses said switching connection software to carry out a follow-up procedure of connecting to said wireless network;
said multi-mode mobile phone uses said switching connection software to determine whether or not said multi-mode mobile phone completes its connection with said wireless network;
if said multi-mode mobile phone completes its connection with said wireless network, then said procedure returns to said multi-mode mobile phone and uses said switching connection software to determine if said multi-mode mobile phone is unable to continue its connection with said wireless network, and carries out said follow-up procedure.

8. The method of claim 7, wherein said multi-mode mobile phone uses said switching connection software to determine if said multi-mode mobile phone is unable to complete its connection with said wireless network, and then said procedure returns to said multi-mode mobile phone and uses said switching connection software to carry out said follow-up procedure of connecting to said mobile communication network, and carries out said follow-up procedure.

9. The method of claim 1, wherein said multi-mode mobile phone includes a compulsory switching connection software, and after said multi-mode mobile phone has performed said compulsory switching connection software, said switching connection software and said reconnection testing procedure are stopped compulsorily, and said multi-mode is specified to connect to said mobile communication network or said wireless local area network until said multi-mode mobile phone stops executing said compulsory switching connection software and then said multi-mode mobile phone continues using said switching connection software and said reconnection testing procedure.

10. The method of claim 1, wherein said mobile communication network and said wireless network separately dial said first number from a remote communication device, and then said remote communication device is connected to said mobile communication network, and said mobile communication network, said wireless network and said multi-mode mobile phone carry out a procedure, so that said remote communication device communicates with said multi-mode mobile phone, and said procedure comprising the steps of:
said mobile communication network determining whether or not said multi-mode mobile phone completes its connection;
said mobile communication network searching said second number of said multi-mode mobile phone according to said first number, if said multi-mode mobile phone is not connected to said mobile communication network;
said mobile communication network issuing a message to said wireless network requesting for connecting said remote communication device to said multi-mode mobile phone, and said remote communication device is connected to said wireless network through said mobile communication network;
said wireless network determining whether or not said multi-mode mobile phone completes its connection;
said wireless network using said second number to dial to said multi-mode mobile phone, if said multi-mode mobile phone completes its connection to said wireless network;
said multi-mode mobile phone receiving a message for carrying out a communication from said remote communication device, and then said multi-mode mobile phone is connected to said remote communication device through said mobile communication network or said wireless network.

11. The method of claim 10, wherein said multi-mode mobile phone completes its connection with said mobile communication network, and then said mobile communication network directly uses said first number to dial to said multi-mode mobile phone; and
said multi-mode mobile phone receives a message requesting for a communication from said remote communication device.

12. The method of claim 10, wherein said wireless network determines whether or not said multi-mode mobile phone completes its connection, and said wireless network issues a message to said mobile communication network for not connecting to said multi-mode mobile phone;
said mobile communication network issues a message for not connecting to said multi-mode mobile phone according to said wireless network, and then issues a message to said remote communication device for not connecting to said multi-mode mobile phone.

13. The method of claim 1, wherein said mobile communication network and said wireless network separately dial said second number from said remote communication device, and then said remote communication device is connected to said mobile communication network, and said mobile communication network, said wireless network and said multi-mode mobile phone carry out a procedure to connect said remote communication device with said multi-mode mobile phone, and said procedure comprising the steps of:
said wireless network determining whether or not said multi-mode mobile phone completes its connection;
if said wireless network determines whether or not said multi-mode mobile phone completes its connection, then said wireless network directly uses said second number to dial to said multi-mode mobile phone; and
said multi-mode mobile phone receiving a message requesting for communicating with said remote communication device.

14. The method of claim 13, wherein said wireless network determines whether or not said multi-mode mobile phone completes its connection and then said wireless network searches said first number of said multi-mode mobile phone according to said second number;
said wireless network issues a message to said mobile communication network requesting for a communication between said remote communication device and said multi-mode mobile phone, and said remote communication device is connected to said mobile communication network through said wireless network mobile communication network, and said mobile communication network determines whether or not said multi-mode mobile phone completes its connection;
if said mobile communication network determines said multi-mode mobile phone has completed its connection, then said mobile communication network uses said first number to dial to said multi-mode mobile phone;
said multi-mode mobile phone receives a message requesting for a communication with said remote communication device, and then said multi-mode mobile phone is connected to said remote communication device through said wireless network or said mobile communication network.

15. The method of claim 14, wherein said mobile communication network determines whether or not said multi-mode mobile phone completes its connection, and then said mobile communication network issues a message to said wireless network for not connecting to said multi-mode mobile phone; and
said wireless network issues a message to said remote communication device for not connecting said multi-mode mobile phone according to said message issued by said multi-mode mobile phone for not connecting to said multi-mode phone.
